(19) United States
(12) Patent Application Publication
(10) Pub. No.: US 2016/0064133 A1
(43) Pub. Date: Mar. 3, 2016

(54) SOLENOID WITH MAGNETIC TUBE AND ARMATURE STABILIZING ELEMENT, AND METHODS OF MAKING AND USING THE SAME

(71) Applicant: HUSCO Automotive Holdings LLC, Waukesha, WI (US)

(72) Inventors: Allen Tewes, Waukesha, WI (US); Austin Schmitt, Menomonee Falls, WI (US); David Ray, Sussex, WI (US)

(21) Appl. No.: 14/843,042

(22) Filed: Sep. 2, 2015

Related U.S. Application Data
(60) Provisional application No. 62/044,597, filed on Sep. 2, 2014.

(51) Int. Cl. H01F 7/121; H01F 7/16

(52) U.S. Cl. CPC H01F 7/121; H01F 7/1607

(57) ABSTRACT

A solenoid can include an armature, a tube including a ferromagnetic tube material, and an armature stabilizing element. The tube can have a radial tube wall with a thickness of less than about 1 mm.

### CROSS-REFERENCE TO RELATED APPLICATIONS

This application claims the benefit of U.S. Provisional Patent Application Ser. No. 62/044,597, filed Sep. 2, 2014, and entitled “SOLENOID WITH MAGNETIC TUBE AND ARMATURE STABILIZING ELEMENT, AND METHODS OF MAKING AND USING THE SAME,” which is hereby incorporated by reference.

### STATEMENT REGARDING FEDERALLY SPONSORED RESEARCH OR DEVELOPMENT

Not Applicable

### BACKGROUND OF THE INVENTION

1. Field of the Invention

The present invention relates to a solenoid having a magnetic tube and an armature stabilizing element, and methods of making and using the same.

2. Description of the Related Art

Solenoids are known with non-magnetic solenoid tubes. Having a non-magnetic tube limits the magnitude of the magnetic field that can be experienced by an armature by virtue of having the non-magnetic material positioned between the coil that produces the magnetic field and the armature.

Solenoids are also known where the tube is absent from the solenoid and the pole piece or pole pieces form a tube-like cavity containing the armature and the inner surface of which directly contacts the armature. However, in all instances having pole pieces directly contacting the armature, the following special manufacturing considerations are required: 1) a non-magnetic coating or surface treatment must be applied to either the armature or the pole pieces, in order to provide a gap between the magnetic material of the armature and the magnetic material of the pole pieces; 2) the pole pieces and/or armature must be additionally processed (grinding, honing, super finishing, etc.) to provide an extra-smooth surface on which the armature slides; and 3) extra care must be taken with respect to contamination (for example, additional components such as filters or diaphragms are included) because any contamination would lead to an increase in surface friction between the armature and pole pieces, and thus would negatively impact performance.

Therefore, there is a desire to provide a solenoid having improved performance characteristics, but not requiring the special manufacturing considerations described above.

### SUMMARY OF THE INVENTION

The present technology overcomes the aforementioned drawbacks by providing systems and methods that have improved performance without requiring coating or surface treatment, additional processing, or extra care for contamination.

In one aspect of the invention, a solenoid is provided. The solenoid can include an armature, a tube, and an armature stabilizing element. The armature can include a magnetic field responsive armature material. The tube can include a ferromagnetic tube material. The armature can have an outer radial armature surface that is parallel to an axial direction. The tube can have a radial tube wall with an inner radial tube surface concentric to the outer radial armature surface. The radial tube wall can have a thickness of less than about 1 mm. The armature stabilizing element can establish a radial air gap between the outer radial armature surface and the inner radial tube surface. The radial air gap can have a substantially uniform thickness over the outer radial armature surface.

In some embodiments, the armature can be substantially cylindrical.

In other embodiments, the armature stabilizing element can include at least two sets of ball bearings. The armature can further include a plurality of channels disposed on the outer radial armature surface along the axial direction. The at least two sets of ball bearings can be positioned within the plurality of channels. Each of the plurality of channels can include at least two sets of bearing stops to define at least two bearing movement zones, wherein at least one ball bearing of the at least two sets of ball bearings can reside in each bearing movement zone.

In yet other embodiments, the solenoid can include a coil disposed around and concentric to the tube. The coil can include a conductive coil material. The coil can be oriented to produce a magnetic field that moves the armature in the axial direction when an electric current passes through the coil. The solenoid can have a maximum stroke of about 3 mm and the armature can generate a push or pull force of: at least about 9 N at a stroke distance of between about 0.25 mm and about 2.5 mm in response to an electric current of about 1 A; or at least about 3 N at a stroke distance of between about 0.25 mm and about 2.5 mm in response to an electric current of about 0.5 A.

In other embodiments, the solenoid can have a maximum stroke of about 3 mm and: the average difference between a push or pull force and a return force is less than about 0.5 N over a stroke distance range from about 0.25 mm and about 2.5 mm; or the difference between a push or pull force and a return force is less than about 0.5 N at a specific stroke distance of between about 0.25 mm and about 2.5 mm.

To the accomplishment of the foregoing and related ends, the technology, then, comprises the features hereinafter fully described. The following description and the annexed drawings set forth in detail certain illustrative aspects of the technology. However, these aspects are indicative of but a few of the various ways in which the principles of the technology can be employed. Other aspects, advantages and novel features of the technology will become apparent from the following detailed description of the technology when considered in conjunction with the drawings.

### BRIEF DESCRIPTION OF THE DRAWINGS

FIG. 1 is a cross-section view of a solenoid according to the present invention;

FIG. 2 is a perspective view of an armature-tube assembly according to the present invention, with the armature removed from the tube;

FIG. 3 is a perspective view of an armature-tube assembly according to the present invention with the armature positioned within the tube;

FIG. 4 is a view of an armature-tube assembly according to the present invention, viewing the solenoid down the bore of the tube;

FIG. 5 is a cross-section view of an armature-tube assembly to the present invention, with the cross-section taken through a set of ball bearings;

FIG. 6 is a plot showing a computer modeled comparison of solenoids with magnetic and non-magnetic tubes;

FIG. 7 is a plot showing measured force-stroke data comparing solenoids with magnetic and non-magnetic tubes;

FIG. 8 is a plot showing measured force-stroke data comparing magnetic-tube solenoids with and without ball bearings;

FIG. 9 is a plot showing measured force-stroke data comparing a solenoid having a magnetic tube and ball bearings with a solenoid having a magnetic tube and no ball bearings; and

FIG. 10 is a schematic cross-section view of an armature-tube assembly showing the magnetic gap for a magnetic versus non-magnetic tube.

While the technology is susceptible to various modifications and alternative forms, specific embodiments thereof have been shown by way of example in the drawings and are herein described in detail. It should be understood, however, that the description herein of specific embodiments is not intended to limit the technology to the particular forms disclosed, but on the contrary, the intention is to cover all modifications, equivalents, and alternatives falling within the spirit and scope of the technology as defined by the appended claims.

### DETAILED DESCRIPTION OF THE INVENTION

Reference herein to directional relationships and movement, such as raise and lower or left and right, refer to the relationship and movement of components in the orientation illustrated in the drawings and on the exemplary application of the invention being described, and other relationships and orientations of the components may exist in other applications of the present invention.

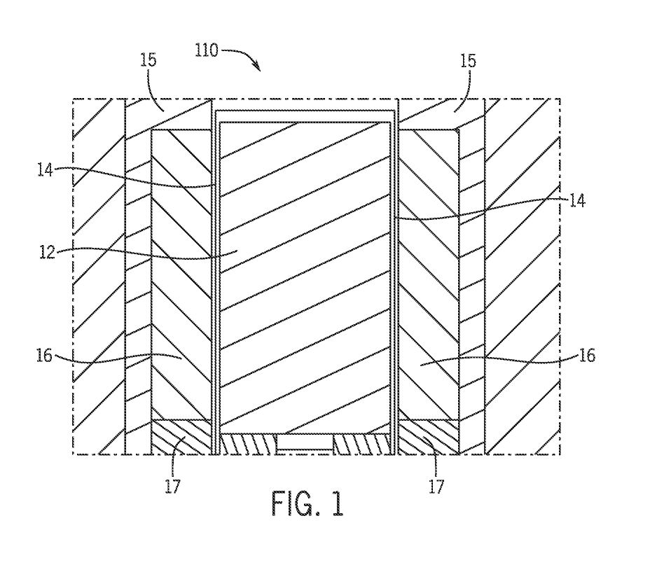

With reference to FIG. 1, this disclosure provides a solenoid 110. The solenoid can include an armature 12, a tube 14, a pole piece 15, a c-pole 17, and a coil 16.

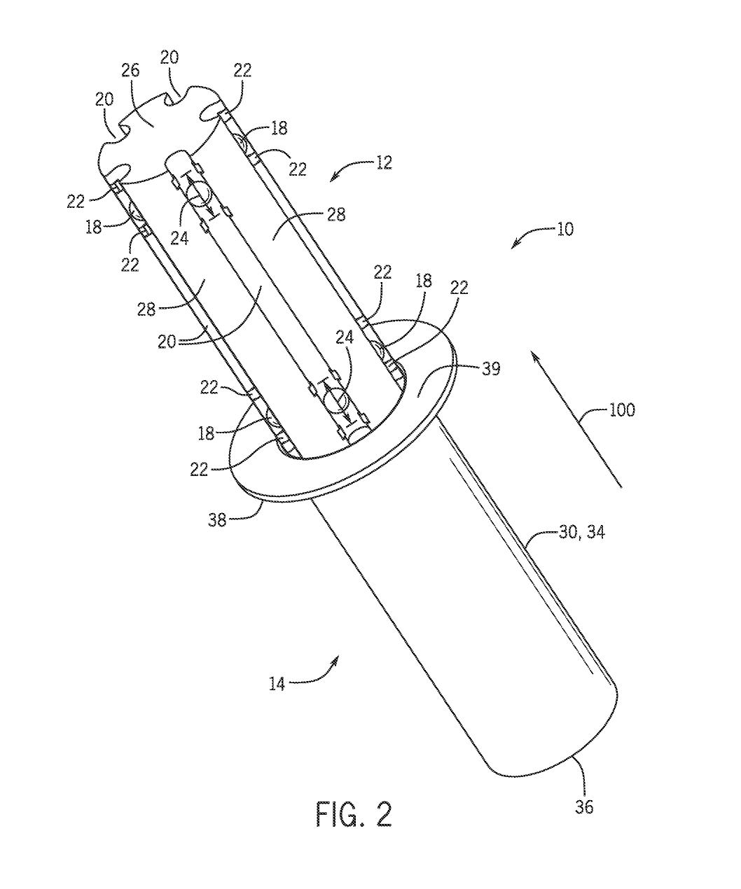

With reference to FIG. 2, the armature 12 and tube 14 combined are referred to as the armature-tube assembly 10. FIG. 2 shows the armature-tube assembly 10 from a perspective with the armature 12 removed from the tube 14. The armature-tube assembly 10 can comprise an armature stabilizing element, shown in the form of ball bearings 18. The tube 14 can slidably receive the armature 12, where the armature 12 can slide relative to the tube 14 along an axial direction 100. The armature 12 can have a first end armature surface 26, an opposing second end armature surface (not visible), and an outer radial armature surface 28. The armature 12 can comprise a plurality of channels 20, in which the armature stabilizing element (e.g., a plurality of ball bearings 18) can be retained. A plurality of bearing stops 22 can define a bearing movement zone 24 in which the ball bearings 18 can move. The armature 12 and tube 14 can have primarily cylindrical shape, with the long axis of the cylindrical shape being aligned with the axial direction 100.

In certain embodiments, the armature stabilizing element can comprise at least two sets of ball bearings 18, with one set of ball bearings 18 nearer the first end armature surface 26 and another set of ball bearings 18 nearer the second end armature surface (not visible). It should be appreciated that the plurality of channels 20 and plurality of ball bearings 18 provide an improved robustness against contamination, because the ball bearings can move around or over contamination (as opposed to two surfaces sliding past one another) and the channels provide space for contamination to accumulate without impacting performance. In addition, because the ball bearings have fewer contact points with the tube, the tube can have more contamination on its inner surface without negatively impacting performance. It should also be appreciated that the armature stabilizing element establishes and maintains the radial air gap and reduces friction between the armature and the tube.

Still referring to FIG. 2, the tube 14 can comprise a radial tube wall 30 having an outer radial tube wall surface 34. The radial tube wall 30 can have a thickness of less than about 1 mm, less than about 500 μm, or less than about 300 μm. The radial tube wall 30 can have a thickness of at least about 1 μm, at least about 50 μm, or at least about 100 μm. The tube 14 can also comprise a flange 38 on an open end 39. The other end 36 can be closed.

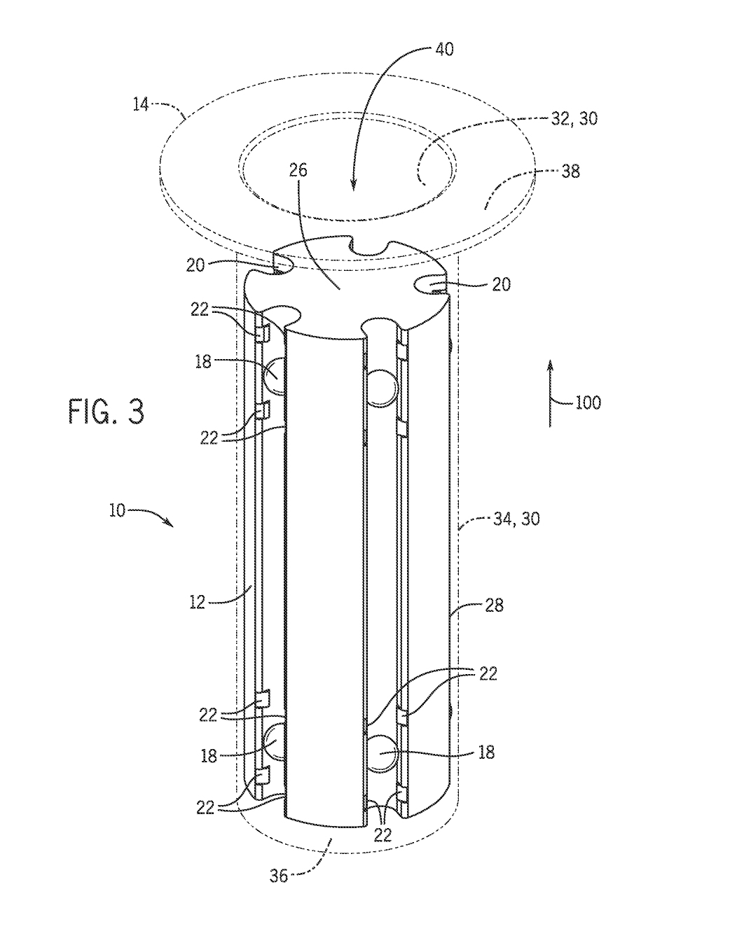

FIG. 3 shows the armature-tube assembly 10 from a perspective with the armature 12 located within the tube 14. The armature 12 and tube 14 can be arranged concentrically. The tube 14 can have a radial tube wall 30 having an inner radial tube wall surface 32 and an outer radial tube wall surface 34. The tube 14 can have an end tube wall 36. The tube 14 can include a flange 38 and an end tube wall 36 on opposite ends of the tube 14. The tube 14 can include an inner bore 40 for receiving the armature. The armature stabilizing element, shown in the form of ball bearings 18, can contact the tube wall 30 at the inner radial tube wall surface 32. The armature stabilizing element or ball bearings 18, the channels 20, and the ball bearing stops 22 can be positioned on the armature 12 to ensure that the armature 12 remains aligned along the axial direction 100 as the armature 12 moves within the tube 14.

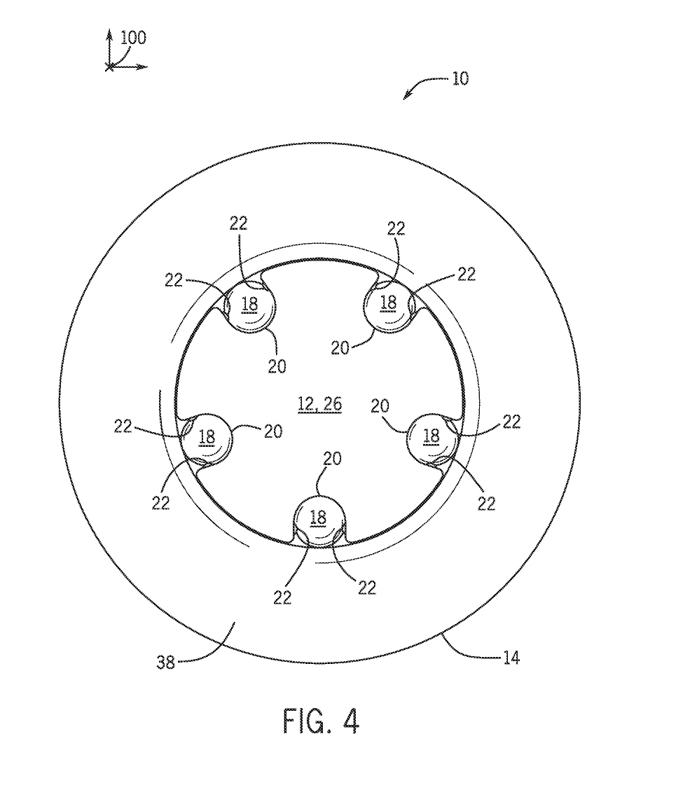

FIG. 4 shows the armature-tube assembly 10 viewed from the end of the first end armature surface 26, looking down the axial direction 100. The plurality of channels 20 can be made in a shape and positioned so that the ball bearings 18 extend a predefined small distance from the armature 12. The plurality of channels 20 can be distributed evenly about the armature 12, so that the armature 12 remains centered within the tube 14.

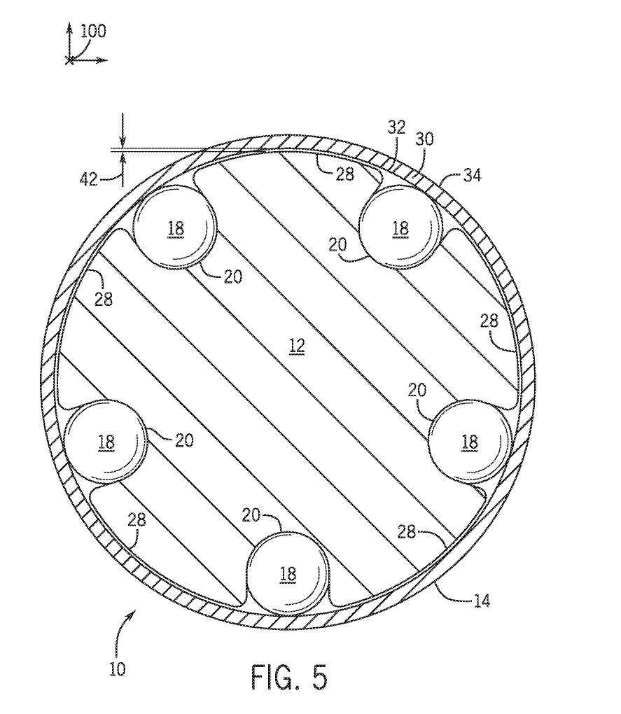

FIG. 5 shows a cross section of the armature-tube assembly 10, with the cross section drawn directly through one set of ball bearings 18, looking down the axial direction 100. The plurality of channels 20 and ball bearings 18 are shaped and positioned to produce a radial air gap 42 between the outer radial armature surface 28 and the inner radial tube wall surface 32. The size of the radial air gap 42 is based on two competing considerations. On the one hand, decreasing the radial air gap improves magnetic efficiency (making a smaller magnetic gap as a result). On the other hand, increasing the radial air gap improves contamination robustness (making more room for contamination that does not negatively impact performance). The radial air gap 42 is controlled by the relative size of the armature 12 and tube 14, as well as the depth of the channels 20 and the size of the ball bearings 18. In certain embodiments, the radial air gap 42 is equal to the predefined small distance that the ball bearings 18 extend from the armature 12.

The radial air gap 42 can have a substantially uniform thickness over the outer radial armature surface 28. The radial air gap can maintain a substantially uniform thickness as the armature 12 moves over at least a portion of a full range of motion of the armature. As used herein, “substantially uniform” shall indicate a tolerance of plus or minus 50% from a mean value, such that a maximum value is less than about 150% of the mean value and a minimum value is at least about 50% of the mean value. In certain embodiments, the radial air gap can have a tolerance of plus or minus 40% from a mean value, plus or minus 30%, plus or minus 20%, or plus or minus 10% from a mean value.

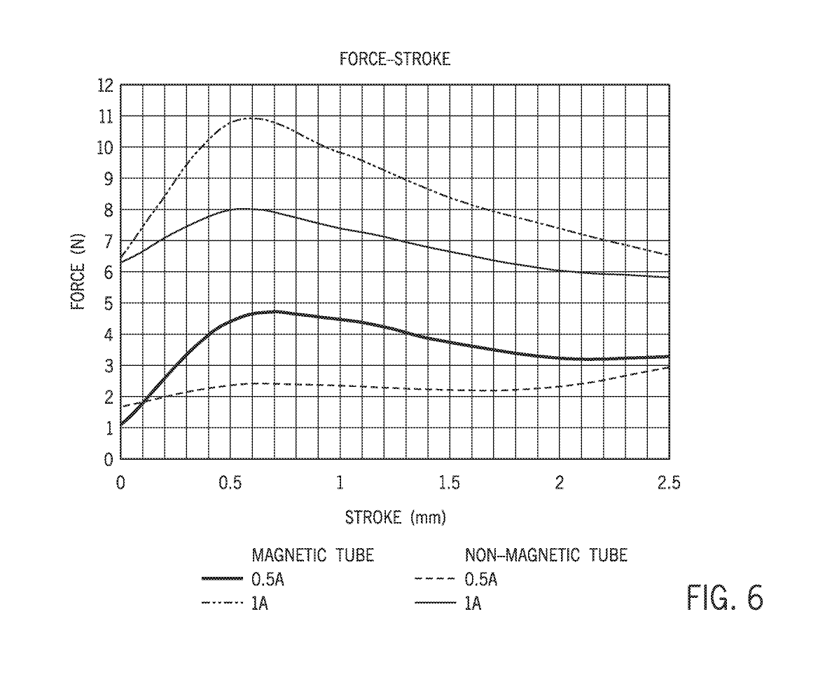

FIG. 6 is a plot showing a computer modeled comparison of solenoids with magnetic and non-magnetic tubes. The force produced is larger at all stroke distances from 0.25 to 2.5 for a current of 0.5 A or 1.0 A. In certain embodiments, the force can be measured for a solenoid having a maximum stroke of about 3 mm.

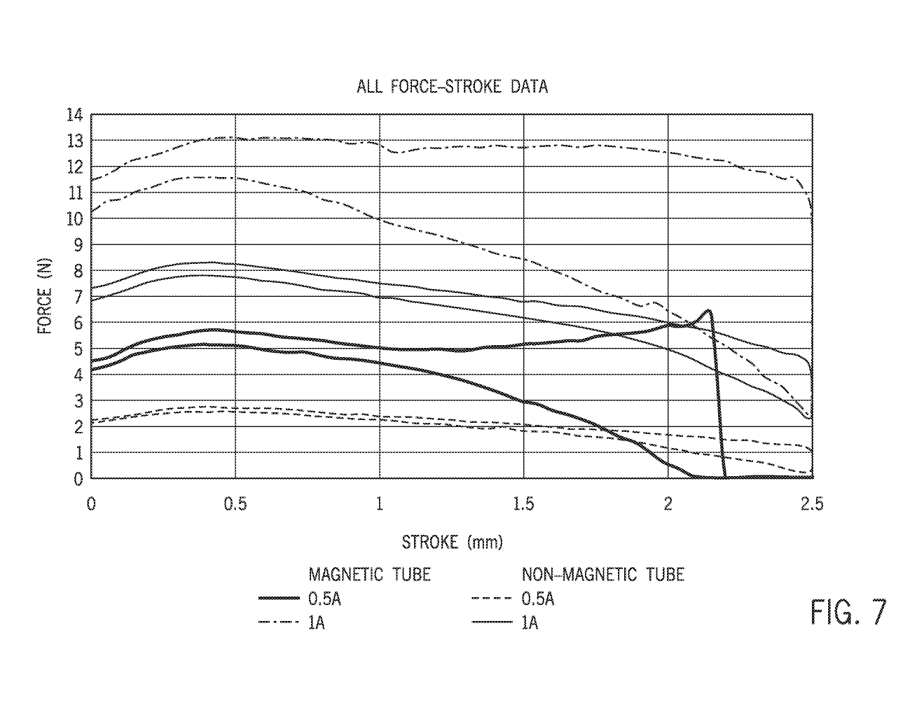

FIG. 7 is a plot of measured force-stroke data comparing solenoids with magnetic and non-magnetic tubes, where the solenoids were the same size and operated at the same currents. The solenoid with a magnetic tube produces a higher stroke force at most distances, but a large hysteresis is introduced between the push or pull force and the return force. As used herein, a push or pull force shall refer to the force exerted by the solenoid as a current through the coil is increased and the armature moves or attempts to move away from a resting position. As used herein, a return force shall refer to the force exerted by the solenoid as a current through the coil is decreased and the armature is forced back to a return position. The armature can be retained in the resting position by a force applied by a linear actuator, such as a spring. Without wishing to be bound by any particular theory, it is believed that an increased magnetic field that results from the use of a magnetic tube can cause increased side loads, which can increase the friction between the armature and the tube, causing a difference between the push or pull force and the return force.

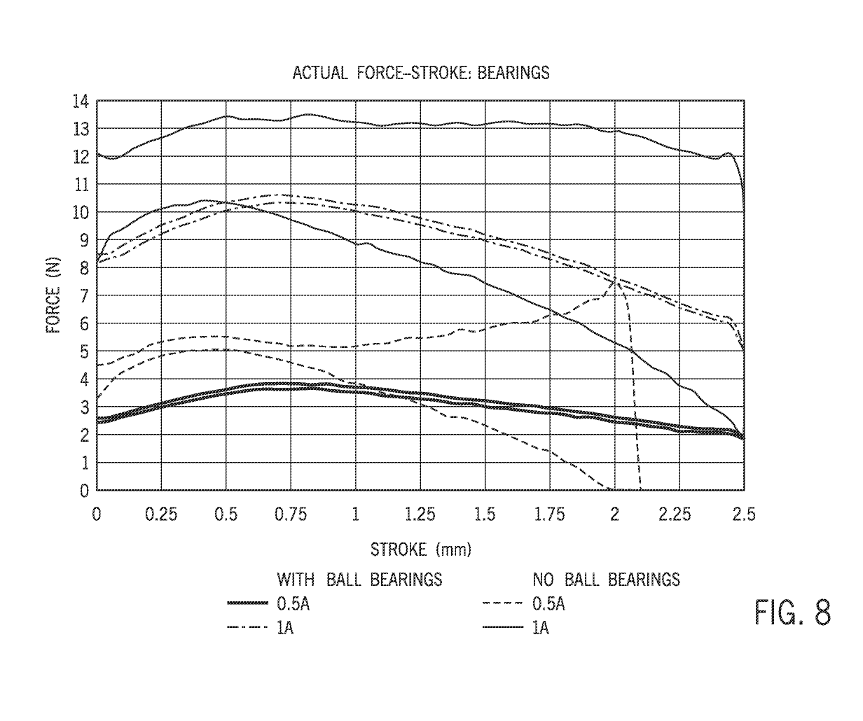

FIG. 8 is a plot of the measured force-stroke data comparing magnetic-tube solenoids with and without ball bearings. The solenoids had the dimensions and operational parameters of the magnetic tube solenoid used for the plot in FIG. 7. As can be seen, the addition of an armature stabilizing element, in the form of ball bearings, and the controlled air gap that results, reduces the hysteresis.

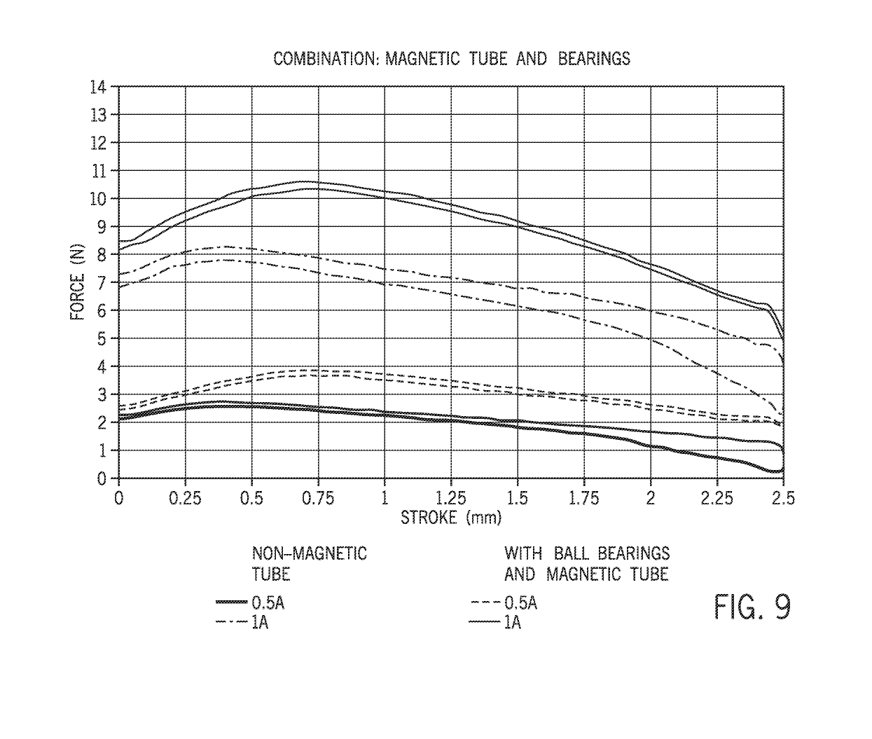

FIG. 9 is a plot of the measured force-stroke data comparing a solenoid having a magnetic tube and ball bearings with a solenoid having a non-magnetic tube and no ball bearings. The solenoids had the dimensions and operational parameters of the solenoids used for the plot in FIG. 7. As can be seen, the presence of the magnetic tube and armature stabilizing element in the form of ball bearings increases the force at all sampled stroke lengths (from 0 mm to 2.5 mm) and showed a reduced hysteresis at most sampled stroke lengths. In certain embodiments, the force can be measured for a solenoid having a maximum stroke of about 3 mm.

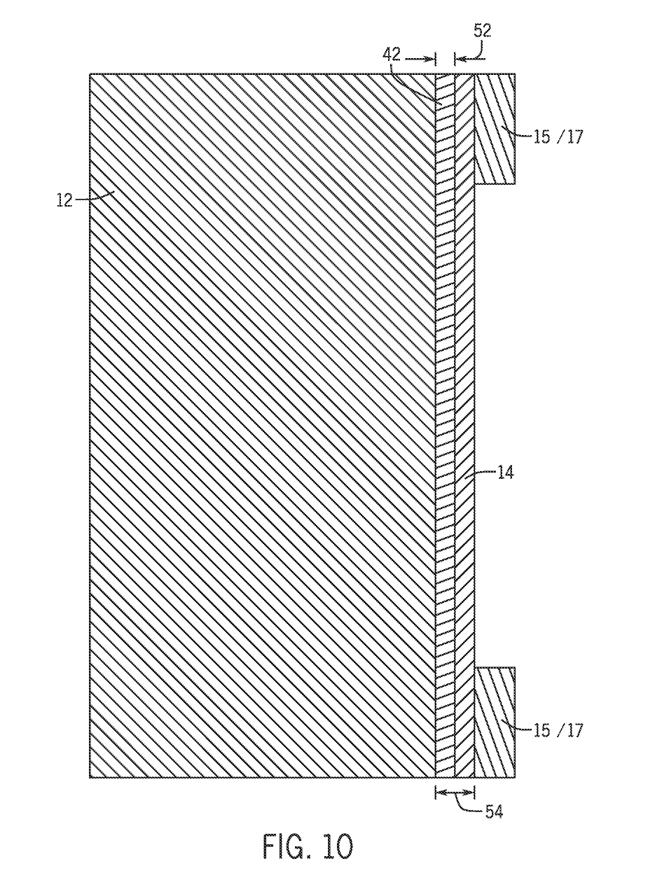

FIG. 10 is a schematic representation of a cross-section of an interface of the armature 12, the radial air gap 42, the tube 14, a pole piece 15, and a c-pole 17 (note, the pole piece 15 and c-pole 17 are interchangeable in this representation) of a solenoid according to the present invention (absent the coil which is not shown). A magnetic gap for embodiments where the tube is magnetic 52 is represented by the distance between the armature 12 and the tube 14. A magnetic gap for instances where the tube is non-magnetic 54 is represented by the distance between the armature 12 and the pole pieces 15.

Solenoids described herein can have a reduced size and mass, as a result of the features described herein. In certain embodiments, the solenoids described herein can have a mass reduced by about 40% without significant changes in performance. For example, a solenoid with a magnetic tube having a coil resistance of 7.9 Ohm, a height of 39.7 mm, a diameter of 23.514 mm, a volume of about 17,240 mm3, and operated over a current range from 0-1 A was shown to provide the same performance as a solenoid with a non-magnetic tube having a coil resistance of 7.8 Ohm, a height of 46 mm, a diameter of 30 mm, a volume of about 32,516 mm3, and was operated over a current range from 0-1 A.

Solenoid tubes as described herein do not require post processing. It should be appreciated that for maximum performance, the magnetic solenoid tube should have a reduced thickness, but a thinner tube cannot be post processed to improve surface finish, roundness, straightness, or the like. Accordingly, the present invention enables use of a thinner magnetic tube that can be manufactured in a single manufacturing step. However, performing one or more of these post processing steps does not necessarily remove the solenoid or methods from the scope of the present invention.

In certain embodiments, the outer radial armature surface or inner radial tube wall surface may not be coated or surface-treated. For the purposes of this invention, a native oxide layer is not considered a coating or surface treatment. Accordingly, the present invention enables use of a magnetic tube and an armature that are not coated or surface-treated and can be manufactured in a single manufacturing step.

The armature 12 can comprise a magnetic field responsive armature material. Suitable magnetic field responsive armature materials include, but are not limited to, iron, cobalt, nickel, gadolinium, ceramics, oxides thereof, alloys thereof, combinations thereof, magnetic stainless steel, magnetic alloys made of non-magnetic constituents, transition metal-metalloid alloys, and the like.

The tube 14 can be magnetic and can comprise a ferromagnetic tube material. Suitable ferromagnetic tube materials include, but are not limited to, iron, cobalt, nickel, gadolinium, ceramics, oxides thereof, alloys thereof, combinations thereof, magnetic stainless steel, magnetic alloys made of non-magnetic constituents, transition metal-metalloid alloys, and the like.

The coil 16 can comprise a conductive coil material. Suitable conductive coil materials include, but are not limited to, copper, gold, silver, aluminum, platinum, conductive organic compounds, semiconductors, oxides thereof, alloys thereof, combinations thereof, and the like.

The armature stabilizing element (such as, the plurality of ball bearings 18) can comprise a magnetic or non-magnetic stabilizing material. Suitable magnetic stabilizing materials include, but are not limited to, iron, cobalt, nickel, oxides thereof, alloys thereof, combinations thereof, magnetic stainless steel, and the like. Suitable non-magnetic stabilizing materials include, but are not limited to, non-magnetic stainless steel, aluminum, copper, plastic, ceramics, oxides thereof, alloys thereof, combinations thereof, and the like.

When the armature stabilizing element is in the form of ball bearings, in certain embodiments, the armature stabilizing element can be a pair of sets of ball bearings, with one set disposed nearer to one end of the armature and the other set disposed nearer to the opposite end of the armature. In certain embodiments, the armature stabilizing element can include two, three, four, five, six, seven, eight, nine, ten, or more sets of ball bearings, with the sets of ball bearings spaced relative to one another sufficiently to maintain the radial air gap by substantially centering the armature within the tube. In certain embodiments, a set of ball bearings includes at least 3 bearings. In certain embodiments, a set of ball bearings includes at least 4 bearings, at least 5, at least 6, or at least 7 bearings.

When the armature stabilizing element is in the form of ball bearings comprising a magnetic stabilizing material, in certain embodiments, a set of ball bearings can include at most 25 bearings, at most 20 bearings, at most 15 bearings, or at most 10 bearings. When the armature stabilizing element is in the form of ball bearings comprising a magnetic stabilizing material, in certain embodiments, the entire armature stabilizing element can include at most 50 bearings, at most 40 bearings, at most 30 bearings, or at most 20 bearings. When the armature stabilizing element is in the form of ball bearings comprising a non-magnetic stabilizing material, in certain embodiments, a set of ball bearings can include at most 25 bearings, at most 20 bearings, at most 15 bearings, or at most 10 bearings. When the armature stabilizing element is in the form of ball bearings comprising a non-magnetic stabilizing material, in certain embodiments, the entire armature stabilizing element can include at most 50 bearings, at most 40 bearings, at most 30 bearings, or at most 20 bearings.

Without wishing to be bound by any particular theory, it is believed that the small contact area between the ball bearings and the magnetic tube allows the air gap to be established over the vast majority of the surface, while having direct contact between the magnetic-responsive material of the armature, the magnetic material of the armature stabilizing element, and the magnetic material of the magnetic tube. The inventors discovered that, despite the direct contact between the materials of the armature, the armature stabilizing element, and the magnetic tube, a combination of the reduced friction from using bearings and the reduced surface area contact between the bearings and the magnetic tube provides improved performance characteristics.

The foregoing description was primarily directed to a preferred embodiment of the invention. Although some attention was given to various alternatives within the scope of the invention, it is anticipated that one skilled in the art will likely realize additional alternatives that are now apparent from disclosure of embodiments of the invention. Accordingly, the scope of the invention should be determined from the following claims and not limited by the above disclosure.

1. A solenoid comprising:
an armature comprising a magnetic field responsive armature material;
a tube comprising a ferromagnetic tube material; and
an armature stabilizing element, the armature having an outer radial armature surface that is parallel to an axial direction,
the tube having a radial tube wall with an inner radial tube surface concentric to the outer radial armature surface, the radial tube wall having a thickness of less than about 1 mm,
the armature stabilizing element establishing a radial air gap between the outer radial armature surface and the inner radial tube surface, the radial air gap having a substantially uniform thickness over the outer radial armature surface and maintaining a substantially uniform thickness as the armature moves over at least a portion of a full range of motion of the armature,
wherein substantially uniform indicates a tolerance of plus or minus 1% from a mean thickness.

2. The solenoid of claim 1, wherein the armature is substantially cylindrical.

3. The solenoid of claim 1, wherein the armature stabilizing element comprises at least two sets of ball bearings.

4. The solenoid of claim 3, wherein the armature further comprises a plurality of channels disposed on the outer radial armature surface along the axial direction, and wherein the at least two sets of ball bearings are positioned within the plurality of channels.

5. The solenoid of claim 4, wherein each of the plurality of channels comprises at least two sets of bearing stops to define at least two bearing movement zones, wherein at least one ball bearing of the at least two sets of ball bearings resides in each bearing movement zone.

6. The solenoid of claim 1, the solenoid further comprising a coil disposed around and concentric to the tube, the coil comprising a conductive coil material, the coil oriented to produce a magnetic field that moves the armature in the axial direction when an electric current passes through the coil.

7. The solenoid of claim 6, wherein the electric current is at least about 1 mA.

8. The solenoid of claim 6, wherein the solenoid has a maximum stroke of about 3 mm and the armature generates a push or pull force of:
at least about 9 N at a specific stroke distance of between about 0.25 mm and about 2.5 mm in response to an electric current of about 1 A; or
at least about 3 N at a specific stroke distance of between about 0.25 mm and about 2.5 mm in response to an electric current of about 0.5 A.

9. The solenoid of claim 1, wherein the solenoid has a maximum stroke of about 3 mm, and wherein an average difference between a push or pull force and a return force is less than about 0.5 N over a stroke distance range from about 0.25 mm and about 2.5 mm.

10. The solenoid of claim 1, wherein the solenoid has a maximum stroke of about 3 mm, and wherein a difference between a push or pull force and a return force is less than about 0.5 N at a specific stroke distance of between about 0.25 mm and about 2.5 mm.

11. A solenoid comprising:
an armature comprising a magnetic field responsive armature material;
a tube comprising a ferromagnetic tube material; and
an armature stabilizing element,
the tube having a radial tube wall with a thickness of less than about 1 mm.

12. The solenoid of claim 11, wherein the armature is substantially cylindrical.

13. The solenoid of claim 11, wherein the armature stabilizing element comprises at least two sets of ball bearings.

14. The solenoid of claim 13, wherein the armature further comprises a plurality of channels disposed on the outer radial armature surface along the axial direction, and wherein the at least two sets of ball bearings are positioned within the plurality of channels.

15. The solenoid of claim 14, wherein each of the plurality of channels comprises at least two sets of bearing stops to define at least two bearing movement zones, wherein at least one ball bearing of the at least two sets of ball bearings resides in each bearing movement zone.

16. The solenoid of claim 11, the solenoid further comprising a coil disposed around and concentric to the tube, the coil comprising a conductive coil material, the coil oriented to produce a magnetic field that moves the armature in the axial direction when an electric current passes through the coil.

17. The solenoid of claim 16, wherein the electric current is at least about 1 mA.

18. The solenoid of claim 16, wherein the solenoid has a maximum stroke of about 3 mm and the armature generates a push or pull force of:
at least about 9 N at a stroke distance of between about 0.25 mm and about 2.5 mm in response to an electric current of about 1 A; or
at least about 3 N at a stroke distance of between about 0.25 mm and about 2.5 mm in response to an electric current of about 0.5 A.

19. The solenoid of claim 11, wherein the solenoid has a maximum stroke of about 3 mm, and wherein an average difference between a push or pull force and a return force is less than about 0.5 N over a stroke distance between about 0.25 mm and about 2.5 mm.

20. The solenoid of claim 11, wherein the solenoid has a maximum stroke of about 3 mm, and wherein a difference between a push or pull force and a return force is less than about 0.5 N at a stroke distance of between about 0.25 mm and about 2.5 mm.
